(19) United States
(12) Patent Application Publication
(10) Pub. No.: US 2020/0285942 A1
(43) Pub. Date: Sep. 10, 2020

(54) METHOD, APPARATUS, ACCELERATOR, SYSTEM AND MOVABLE DEVICE FOR PROCESSING NEURAL NETWORK

(71) Applicant: SZ DJI TECHNOLOGY CO., LTD., Shenzhen (CN)

(72) Inventors: Zhao YAN, Shenzhen (CN); Lan DONG, Shenzhen (CN); Lin CHEN, Shenzhen (CN); Sijin LI, Shenzhen (CN); Mingming GAO, Shenzhen (CN)

(21) Appl. No.: 16/884,729

(22) Filed: May 27, 2020

Related U.S. Application Data
(63) Continuation of application No. PCT/CN2017/113932, filed on Nov. 30, 2017.

(51) Int. Cl. G06N 3/04; G06N 3/063

(52) U.S. Cl. CPC G06N 3/0454; G06N 3/0635

(57) ABSTRACT

A method for processing across neural networks includes: when processing a last block of a plurality of blocks of an i-th layer of a first neural network, reading data of a first block of a plurality of blocks of a k-th layer of a second neural network from a memory; and processing the first block of the plurality of blocks of the k-th layer of the second neural network according to the data of the first block of the plurality of blocks of the k-th layer of the second neural network after processing the last block of the plurality of blocks of the i-th layer of the first neural network. 1≤i≤N, N is a number of layers of the first neural network; and 1≤k≤M, M is a number of layers of the second neural network.

### CROSS-REFERENCE TO RELATED APPLICATION

This application is a continuation of International Application No. PCT/CN2017/113932, filed Nov. 30, 2017, the entire content of which is incorporated herein by reference.

### TECHNICAL FIELD

The present disclosure relates to the field of information technology, and more particularly, to a method, an apparatus, an accelerator, a computer system, and a movable device for neural network processing.

### BACKGROUND

Convolutional Neural Network (CNN) is a complex and non-linear hypothetical model. The model parameters used are obtained through training and learning, and have the ability to fit data.

CNN can be applied to scenarios such as machine vision and natural language processing. When implementing CNN algorithms in embedded systems, full consideration must be given to computing resources and real-time performance. Neural network processing consumes a lot of resources. Accordingly, how to improve the utilization of computing resources has become an urgent technical issue in neural network processing.

### SUMMARY

In accordance with the disclosure, there is provided a method for processing across neural networks. The method includes: when processing a last block of a plurality of blocks of an i-th layer of a first neural network, reading data of a first block of a plurality of blocks of a k-th layer of a second neural network from a memory; and processing the first block of the plurality of blocks of the k-th layer of the second neural network according to the data of the first block of the plurality of blocks of the k-th layer of the second neural network after processing the last block of the plurality of blocks of the i-th layer of the first neural network. 1≤i≤N, N is a number of layers of the first neural network; and 1≤k≤M, M is a number of layers of the second neural network.

Also in accordance with the disclosure, there is provided another method for processing across neural networks. The method includes receiving address information of a configuration description table and a start command sent by a processor, reading the configuration description table of the first layer of the first neural network from the memory according to the address information of the configuration description table, processing the first layer of the first neural network according to the configuration description table of the first layer of the first neural network, determining an address of the configuration description table of a j-th layer of the first neural network in the memory according to a preset address offset, reading the configuration description table of the j-th layer from the memory according to the address of the configuration description table of the j-th layer, processing the j-th layer according to the configuration description table of the j-th layer and sending an interrupt request to the processor after processing the N-th layer of the first neural network. The address information of the configuration description table is configured to indicate an address of a configuration description table of a first layer of a first neural network in a memory, the memory stores configuration description tables of all layers of the first neural network, a configuration description table of an i-th layer of the first neural network includes configuration parameters for processing the i-th layer, and the start command is configured to instruct a start of processing the first neural network. 1≤i≤N and 2≤j≤N is a number of layers of the first neural network.

Also in accordance with the disclosure, there is provided an apparatus for processing across neural networks. The apparatus includes an accelerator and a memory. The accelerator is configured to: when processing a last block of a plurality of blocks of an i-th layer of a first neural network, 1≤i≤N, read data of a first block of a plurality of blocks of a k-th layer of a second neural network from the memory, N being a number of layers of the first neural network, 1≤k≤M, and M being a number of layers of the second neural network; and process the first block of the plurality of blocks of the k-th layer of the second neural network according to the data of the first block of the plurality of blocks of the k-th layer of the second neural network, after processing the last block of the plurality of blocks of the i-th layer of the first neural network.

Also in accordance with the disclosure, there is provided an accelerator. The accelerator includes a module configured to perform a method for processing across neural networks. The method includes: when processing a last block of a plurality of blocks of an i-th layer of a first neural network, reading data of a first block of a plurality of blocks of a k-th layer of a second neural network from a memory; and processing the first block of the plurality of blocks of the k-th layer of the second neural network according to the data of the first block of the plurality of blocks of the k-th layer of the second neural network after processing the last block of the plurality of blocks of the i-th layer of the first neural network. 1≤i≤N, N is a number of layers of the first neural network, 1≤k≤M, and M is a number of layers of the second neural network.

Also in accordance with the disclosure, there is provided a movable device for processing across neural networks. The movable device includes an accelerator and a computer system. The computer system includes a memory for storing executable computer instructions, and a processor for executing the executable computer instructions stored in the memory. The accelerator is configured to: when processing a last block of a plurality of blocks of an i-th layer of a first neural network, read data of a first block of a plurality of blocks of a k-th layer of a second neural network from the memory, 1≤i≤N, N being a number of layers of the first neural network, 1≤k≤M, and M being a number of layers of the second neural network; and process the first block of the plurality of blocks of the k-th layer of the second neural network according to the data of the first block of the plurality of blocks of the k-th layer of the second neural network, after processing the last block of the plurality of blocks of the i-th layer of the first neural network.

### BRIEF DESCRIPTION OF THE DRAWINGS

FIG. 1 is a schematic diagram of a neural network;

FIG. 2 is a schematic diagram of a technical solution according to some embodiment of the present disclosure;

FIG. 3 is a schematic diagram of a movable device according to some embodiment of the present disclosure;

FIG. 4 illustrates a first flowchart of a neural network processing method according to some embodiment of the present disclosure;

FIG. 5 is a schematic diagram of a neural network block according to some embodiment of the present disclosure;

FIG. 6 illustrates a flowchart of interleaved multiple neural network processing according to some embodiment of the present disclosure;

FIG. 7 illustrates a second flowchart of a neural network processing method according to some embodiment of the present disclosure;

FIG. 8 is a schematic block diagram of a neural network processing apparatus according to some embodiment of the present disclosure;

FIG. 9 is a schematic block diagram of a neural network processing apparatus according to another embodiment of the present disclosure; and

FIG. 10 is a schematic block diagram of a computer system according to some embodiment of the present disclosure.

### DETAILED DESCRIPTION OF THE EMBODIMENTS

The technical solutions in the embodiments of the present disclosure are described below with reference to the drawings.

It should be understood that the specific examples herein are only intended to help those skilled in the art to better understand the embodiments of the present disclosure, but not to limit the scope of the embodiments of the present disclosure.

It should also be understood that, in various embodiments of the present disclosure, the sequence number of each process does not indicate the order of execution, and the order of execution of each process should be determined by its function and internal logic, and should not impose any limitation on the implementation process of the embodiments of the present disclosure.

It should also be understood that the various embodiments described in this specification can be implemented individually or in combination, and are not limited to the embodiments of the present disclosure.

The technical solution of the embodiments of the present disclosure can be applied to various neural networks, such as CNN, but the embodiments of the present disclosure are not limited thereto.

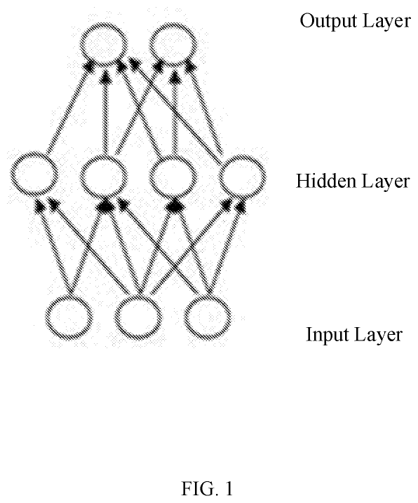

FIG. 1 is a schematic diagram of a neural network. As shown in FIG. 1, a neural network may include multiple layers; that is, an input layer, one or more hidden layers, and an output layer. The hidden layers in a neural network can be all fully connected layers, and can also include both convolutional layers and fully connected layers, the latter of which are called a convolutional neural network.

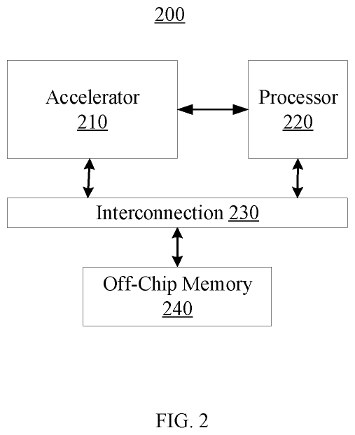

FIG. 2 is a schematic diagram of a technical solution according to some embodiment of the present disclosure.

As shown in FIG. 2, the system 200 may include an accelerator 210, a processor 220, an interconnection 230, and an off-chip memory 240. The accelerator 210 and the processor 220 are disposed on-chip, and can access the off-chip memory 240 through the interconnection 230.

The off-chip memory 240 is configured to store data. The processor 220 may be, for example, an embedded processor, for configuration and interrupt response of the accelerator 210.

The accelerator 210 is configured to implement data processing. Specifically, the accelerator 210 may read input data (e.g., input feature maps and weights) from the memory 240, e.g., read into an on-chip memory (on-chip cache) in the accelerator 210, and process the input data, e.g., performing convolution on the input data, Bias Activation Pooling (BAP) operations to obtain output data, and storing the output data in the memory 240.

In some embodiments, the system 200 may be disposed in a movable device. The movable device may be an unmanned aerial vehicle (UAV), an unmanned ship, an autonomous vehicle, or a robot, and the embodiment of the present disclosure is not limited hereto.

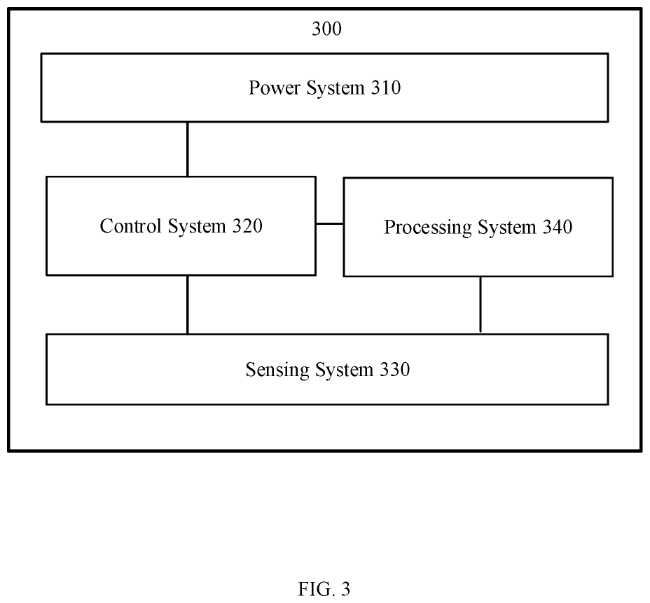

FIG. 3 is a schematic diagram of a movable device according to some embodiment of the present disclosure.

As shown in FIG. 3, a movable device 300 may include a power system 310, a control system 320, a sensing system 330, and a processing system 340.

The power system 310 is configured to supply power to the movable device 300.

Taking a UAV as an example, the power system of the UAV may include an electronic speed control (referred to as an ESC), a propeller, and a motor corresponding to the propeller. The motor is connected between the ESC and the propeller, and the motor and the propeller are disposed on corresponding arms. The ESC is configured to receive a driving signal generated by the control system and supply a driving current to the motor according to the driving signal to control a rotation speed of the motor. The motor is configured to drive the propellers to rotate, thereby supplying power to the UAV.

The sensing system 330 can be configured to measure the attitude information of the movable device 300, that is, the position information and status information of the movable device 300 in space, such as three-dimensional position, three-dimensional angle, three-dimensional velocity, three-dimensional acceleration, and three-dimensional angular velocity. The sensing system 330 may include at least one of sensors such as a gyroscope, an electronic compass, an inertial measurement unit (IMU), a vision sensor, a global positioning system (GPS), a barometer, or an airspeed meter.

The sensing system 330 may also be configured to acquire images; that is, the sensing system 330 includes sensors for acquiring images, such as a camera.

The control system 320 is configured to control a movement of the movable device 300. The control system 320 may control the movable device 300 according to a preset program instruction. For example, the control system 320 may control the movement of the movable device 300 according to attitude information of the movable device 300 measured by the sensing system 330. The control system 320 may also control the movable device 300 according to a control signal from a remote control. For example, for a UAV, the control system 320 may be a flight control system (flight control), or a control circuit in the flight control.

The processing system 340 may process images acquired by the sensing system 330. For example, the processing system 340 may be an image signal processing (ISP) chip.

The processing system 340 may be the system 200 as shown in FIG. 2; or, the processing system 340 may include the system 200 as shown in FIG. 2.

It should be understood that the foregoing division and naming of each component of the movable device 300 is merely exemplary, and should not be construed as to limit the embodiments of the present disclosure.

It should also be understood that the movable device 300 may further include other components not shown in FIG. 3, which is not limited by the embodiment of the present disclosure.

The neural network is processed by layers; that is, after a calculation of one layer is completed, a calculation of a next layer is started until the last layer is calculated.

Due to limited on-chip storage resources, when processing each layer, it may not be possible to read all data of that layer into the on-chip memory. Accordingly, a block processing method can be implemented for each layer. That is, an input feature (IF) map of each layer is divided into a plurality of blocks, and one block of data is read into the on-chip memory at a time.

In some specific applications, one accelerator may process multiple neural networks with different functions at the same time. The current solution is to process multiple neural networks in sequence, which may cause waiting time, waste computing resources and affect calculating resource utilization rate.

In view of this, in some embodiments of the present disclosure, a technical solution to improve the utilization rate of computing resources by interleaving multiple neural networks is provided. The technical solutions in the embodiments of the present disclosure are described in detail below.

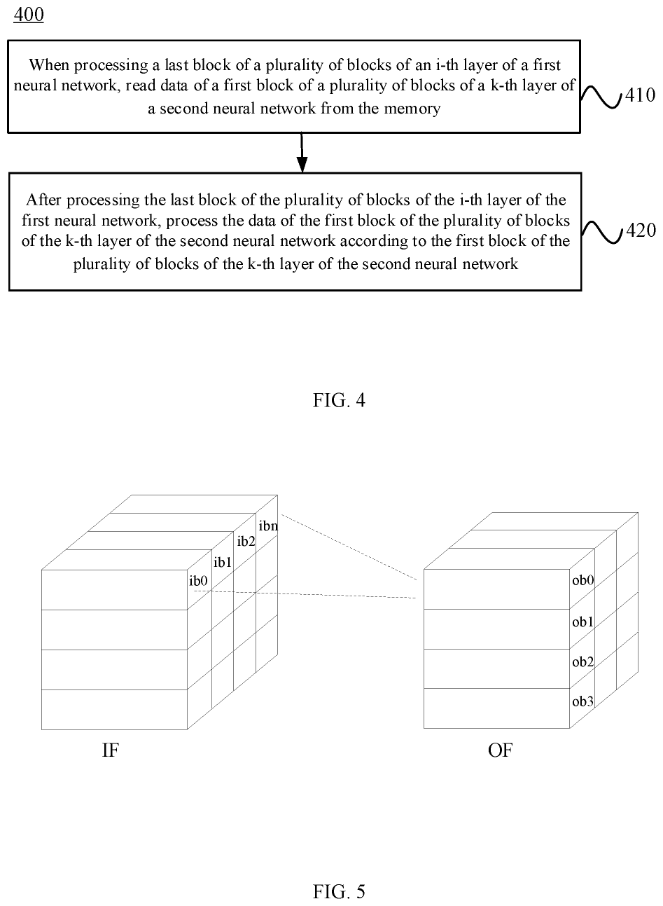

FIG. 4 illustrates a flowchart of a neural network processing method according to some embodiment of the present disclosure. The method 400 may be performed by an accelerator, i.e., may be performed by the accelerator 210 as shown in FIG. 2.

410: When processing a last block of a plurality of blocks of an i-th layer of a first neural network, reading data of a first block of a plurality of blocks of a k-th layer of a second neural network from the memory. 1≤i≤N, N is the number of layers of the first neural network; and 1≤k≤M, M is the number of layers of the second neural network.

An output feature (OF) map of a previous layer of the neural network may be used as the IF of the next layer of the neural network. However, when performing block processing on each layer of the neural network, one block of the OF of one layer (that is, the IF of the next layer) may depend on multiple blocks of the IF of this layer. As shown in FIG. 5, a block ob0 of the OF may depend on multiple blocks ib0-ibn of the IF of this layer. As such, a next layer of the same neural network is processed after all the blocks of the previous layer are processed. In the case of processing multiple neural networks at the same time, there is no data dependency among layers of different neural networks. Therefore, in the embodiments of the present disclosure, when processing the last block of a certain layer (i.e., the i-th layer) of the first neural network, data of a certain layer (i.e., the k-th layer) of the second neural network may be read. In other words, the k-th layer of the second neural network need not be processed after all the blocks of the i-th layer of the first neural network are processed; rather, data of the first block of the k-th layer of the second neural network can be processed when the last block of the i-th layer of the first neural network is being processed.

420: After processing the last block of the plurality of blocks of the i-th layer of the first neural network, processing the data of the first block of the plurality of blocks of the k-th layer of the second neural network according to the first block of the plurality of blocks of the k-th layer of the second neural network.

Since the data of the first block of the k-th layer of the second neural network is read when the last block of the i-th layer of the first neural network is being processed, accordingly, after the last block of the i-th layer of the first neural network is processed, the data of the first block of the k-th layer of the second neural network that has been read can be used. Therefore, the technical solution in the embodiments of the present disclosure may reduce the waiting time and improve the utilization rate of computing resources.

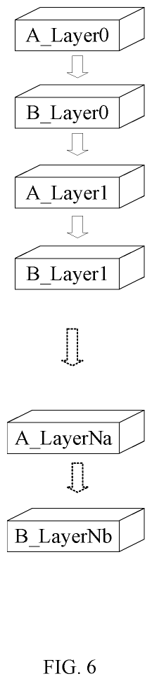

The above processing method for multiple neural networks may be referred to as an interleaving processing method. FIG. 6 illustrates a flowchart of an interleaved multiple neural network processing. As shown in FIG. 6, two neural networks A and B are taken as an example. The two neural networks A and B are time-division multiplexed in an interleaved manner. The adjacent two layers have data of different networks and there is no data dependent relationship between them. When the data of the last block of the current layer of the neural network A is being processed, the data of the neural network B layer can be read from an external memory, and there is no need to wait for the current layer of the neural network A to finish processing before starting the reading the data of next layer. After the current layer of the neural network A is processed, the processing of the layer of the neural network B can immediately start using the data that has been read in, thereby achieving the beneficial effect of improving the utilization rate of computing resources.

It should be understood that although two neural networks are taken as an example in the above description, the embodiments of the present disclosure are not limited thereto. That is, the technical solution in the embodiments of the present disclosure can be applied to processing more neural networks at the same time.

For example, if it is also necessary to process a third neural network at the same time, when processing the last block of the plurality of blocks in the k-th layer of the second neural network, data of a first block of a plurality of blocks of an 1-th layer of the third neural network may be read from the memory. 1≤1≤P, where P is the number of layers of the third neural network. After processing the last block of the plurality of blocks in the k-th layer of the second neural network, the first block of the plurality blocks of the 1-th layer of the third neural network may be processed according to the data of the first block of the plurality of blocks of the 1-th layer of the third neural network.

In the technical solution of the embodiments of the present disclosure, when processing the last block of the i-th layer of the first neural network, the data of the first block of the k-th layer of the second neural network may be read. After the last block of the i-th layer is processed, the first block of the k-th layer of the second neural network may be processed according to the data that has been read, which can reduce the waiting time during processing, thereby improving the utilization rate of computing resources.

Optionally, in some embodiment of the present disclosure, the memory may be an off-chip memory. In other words, the data of the neural network is stored in the off-chip memory.

Optionally, in some embodiment of the present disclosure, a size of the block is determined according to the size of the on-chip memory. For example, the size of the block may be equal to or slightly smaller than the size of the on-chip memory.

In some embodiment of the present disclosure, optionally, when processing each layer of the neural network, the process may be performed based on a configuration description table.

Optionally, in some embodiment of the present disclosure, the configuration description tables of all layers of the neural network may be stored in the memory. The configuration description table includes configuration parameters for processing all layers of the neural network.

Optionally, in some embodiment of the present disclosure, the configuration parameters may include an address of input data in the memory, an address of output data in the memory, a processing instruction, etc.

For example, the configuration description of the i-th layer includes the address of the input data of the i-th layer in the memory, the address of the output data of the i-th layer in the memory, and the processing instructions for the i-th layer. The configuration description table for the k-th layer includes the address of the input data of the k-th layer in the memory, the address of the output data of the k-th layer in the memory, and the processing instructions for the k-th layer.

Optionally, in some embodiment of the present disclosure, an address corresponding to a block of a layer may be determined according to an address corresponding to the layer. For example, the address of the input data of each block of the i-th layer in the memory may be determined according to the address of the input data of the i-th layer in the memory, and the address of the output data of each block of the i-th layer may be determined according to the address of the output data of the i-th layer in the memory. In other words, according to the size of the block, a corresponding block can be determined, and accordingly, data can be read from or written into the corresponding block.

Optionally, in some embodiment of the present disclosure, the configuration description table may be read from the memory according to the address information of the configuration description table sent by the processor, and the data of a block to be processed may be read from the memory according to the configuration description table. Optionally, the address information of the configuration description table is configured to indicate the address of the configuration description table of the initial layer in the memory. The initial layer may be the first layer of each neural network, or the first layer of the first neural network in the processing order. In such a case, the configuration description table of the initial layer may be read from the memory according to the address information of the configuration description table. According to the address information of the configuration description table and a preset address offset, the configuration description table of other layers may be read from the memory.

Optionally, in some embodiment of the present disclosure, the processor may send the address information of the configuration description table and a start command to the accelerator. The address information of the configuration description table is configured to indicate the address of the configuration description table of the first-layer of the neural network in the memory. The start command is configured to instruct a start to process the neural network. The accelerator may read the configuration description table of the first layer of the neural network from the memory according to the address information of the configuration description table, determine the address of the configuration description table of the next layer of the neural network in the memory according to a preset address offset, process each layer of the neural network according to the configuration description table of each layer, and send an interrupt request to the processor after all layers of the neural network have been processed. Optionally, the interrupt request includes an address of a processing result (that is, final output data) of the neural network in the memory. Through the above technical solution, the interaction between the processor and the accelerator can be reduced, and the load on the processor can be reduced, thereby reducing system resource occupation.

Optionally, in some embodiment of the present disclosure, when processing multiple neural networks at the same time, the configuration description table of the k-th layer of the second neural network may be read from the memory when processing the last block of the plurality of blocks of the i-th layer of the first neural network, and the address of the data of the first block of the plurality of blocks of the k-th layer in the memory may be determined according to the configuration description table of the k-th layer, and the data of the first block of the plurality of blocks of the k-th layer may be read from the memory. After processing the last block of the plurality of blocks of the i-th layer of the first neural network, according to the configuration description table of the kth layer and the data of the first block of the plurality of blocks of the k-th layer, the first block of the plurality of blocks of the k-th layer can be processed.

Specifically, when processing multiple neural networks at the same time, the processor may store the configuration description tables of the multiple neural networks in the memory, and send the address information of the configuration description table and start commands of the multiple neural networks to the accelerator. Optionally, the address information of the configuration description table and the start command of each neural network may be sent when the processing of the neural network is started. After receiving the address information of the configuration description table and the start command of the first neural network, the accelerator can read the configuration description table of the first layer of the first neural network from the memory according to the address information of the configuration description table of the first neural network, and process each block of the first layer of the first neural network sequentially according to this configuration description table. If the processing of the second neural network is started at the same time; that is, the address information of the configuration description table and the start command of the second neural network are received, then the accelerator can read the configuration description table of the first layer of the second neural network from the memory according to the address information of the configuration description table of the second neural network when processing the last block of the first layer of the first neural network, read the data of the first block of the first layer of the second neural network from the memory according to the configuration description table, and process the first block of the first layer of the second neural network after processing the last block of the first layer of the first neural network, then process all the blocks of the first layer of the second neural networks. Similarly, the accelerator can determine the address of the second layer of the first neural network in the memory according to the address information of the configuration description table and the preset address offset of the first neural network when processing the last block of the first layer of the second neural network, and read the configuration description table of the second layer of the first neural network from the memory, and read the data of the first block of the second layer of the first neural network from the memory according to the configuration description table, and process the first block of the second layer of the first neural network after processing the last block of the first layer of the second neural network, and so on.

It should be understood that the configuration description table of each layer of multiple neural networks may also be set at the same time. For example, the configuration description table of each layer may be stored in the memory in accordance with the processing order, and an address offset may be preset between each other. In this way, the processor may only send the address of the configuration description table of the first layer of the first neural network to the accelerator, and subsequently may sequentially determine the address of the configuration description table of the next layer to be processed according to the preset address offset.

In the technical solution of the embodiments of the present disclosure, by interleaving multiple neural networks, the waiting time during processing can be reduced, thereby improving the utilization rate of computing resources. In addition, the neural network is processed according to the address information of the configuration description table and the configuration description table, so that the interaction between the processor and the accelerator can be reduced, and the load on the processor can be reduced, thereby reducing the system resource occupation.

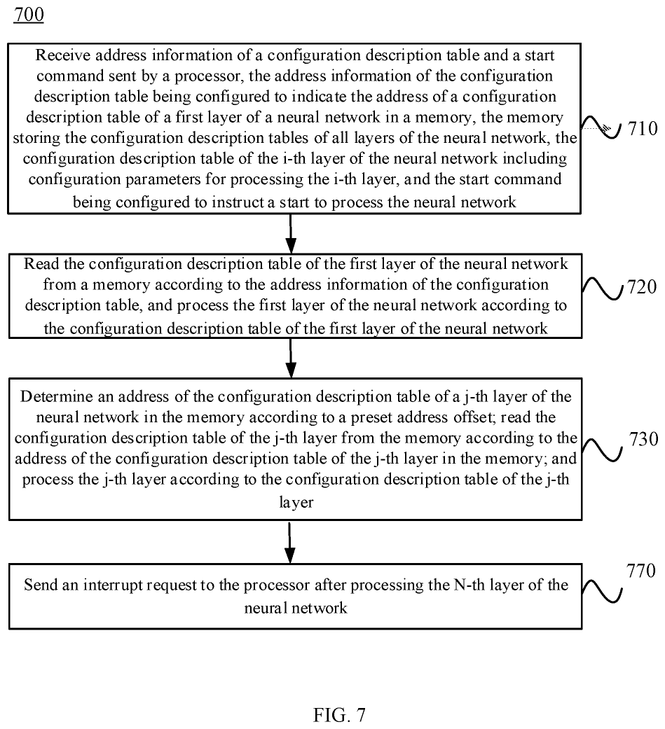

It should be understood that in the foregoing described embodiments of the present disclosure, the technical solution for interleaving processing of multiple neural networks and the technical solution for processing neural networks using the address information of the configuration description table may be implemented jointly or separately. Based on this, another embodiment of the present disclosure provides another neural network processing method, which is described below with reference to FIG. 7. It should be understood that reference may be made to the foregoing embodiments for detailed descriptions of the method shown in FIG. 7. For brevity, the details are not described herein again.

FIG. 7 illustrates a flowchart of a neural network processing method according to another embodiment of the present disclosure. The method 700 may be performed by an accelerator, i.e., the accelerator 210 in FIG. 2. As shown in FIG. 7, the method 700 includes:

710: Receiving address information of a configuration description table and a start command sent by a processor. The address information of the configuration description table is configured to indicate the address of a configuration description table of a first layer of a neural network in a memory. The memory stores the configuration description tables of all layers of the neural network. The configuration description table of the i-th layer of the neural network includes configuration parameters for processing the i-th layer. The start command is configured to instruct a start to process the neural network, 1≤i≤N, and N is the number of layers of the neural network.

720: Reading the configuration description table of the first layer of the neural network from a memory according to the address information of the configuration description table, and processing the first layer of the neural network according to the configuration description table of the first layer of the neural network.

730: Determining an address of the configuration description table of a j-th layer of the neural network in the memory according to a preset address offset, 2≤j≤N; reading the configuration description table of the j-th layer from the memory according to the address of the configuration description table of the j-th layer in the memory; and processing the j-th layer according to the configuration description table of the j-th layer.

740: Sending an interrupt request to the processor after processing the N-th layer of the neural network.

In the embodiments of the present disclosure, all configuration files of the neural network, including data and configuration description tables, are stored in the memory (e.g., an off-chip memory) in advance.

Optionally, the input data of each layer may include input feature maps, weights, offsets, etc.

Optionally, the configuration description table of each layer may include an address of the input data of the layer in the memory, an address of the output data of the layer in the memory, and the processing instructions for the layer.

When there is an image input, the processor sends the address information of the configuration description table of the neural network and a start command to the accelerator.

The accelerator can read data of a fixed-length configuration description table from the memory according to an address of a current configuration description table, parse the contents of each field, and read the input data from the memory according to the content of the configuration description table and process the input data. For example, perform convolution and BAP operations on the input data to obtain the output data, and the output data may be stored in the memory until all processing of the current layer is completed.

After finishing processing one layer, the accelerator determines whether the current layer is the last layer of the neural network. If it is not the last layer, a preset address offset may be added to an address pointer of the configuration description table to obtain the address of a configuration description table of a next layer of the neural network, then the accelerator continues to process the next layer. If the current layer is the last layer of the neural network, it is indicated that the processing of the current image is completed, and a completion interrupt request is sent to the processor. The interrupt request may include an address of a processing result of the neural network in the memory.

After processing of the current input image, the accelerator enters a waiting state until there is a new input image, and the above steps are repeated, so that a continuous input image processing can be achieved.

In the technical solution of the embodiments of the present disclosure, all the configuration parameters processed by the neural network are stored in the memory. When the operation starts, the processor sets an address of an initial configuration description table and a start command. There is no load on the processor during the process until the current input image calculation is completed, then the processor receives an interrupt request from the accelerator and uses the calculated result for subsequent applications. Accordingly, the software and hardware interaction process of the technical solution in the embodiments of the present disclosure is extremely simple, and the load on the processor is very small, so that the system resource occupation can be greatly reduced.

Optionally, in the case of processing multiple neural networks at the same time, when processing the last block of the plurality of blocks of the i-th layer of the neural network, the configuration description table of the k-th layer of another neural network may be read from the memory. According to the configuration description table of the k-th layer, data of the first block of the plurality of blocks of the k-th layer may be read from the memory, 1≤k≤M, where M is the number of layers of the other neural network. After processing the last block of the plurality of blocks of the i-th layer of the neural network, according to the configuration description table of the k-th layer and the data of the first block of the plurality of blocks of the k-th layer, the first block of the plurality of blocks of the k-th layer may be processed. For a detailed description of processing multiple neural networks at the same time, reference may be made to the foregoing embodiments. For brevity, details are not described herein again.

The neural network processing method according to the embodiments of the present disclosure is described in detail above. The neural network processing apparatus, accelerator, computer system, and movable device according to the embodiment of the present disclosure is described below. It should be understood that the neural network processing apparatus, accelerator, computer system, and movable device in the embodiments of the present disclosure can perform the foregoing method embodiments of the present disclosure. That is, the specific operating processes of the following various products can be referred to the corresponding processes in the foregoing method embodiments.

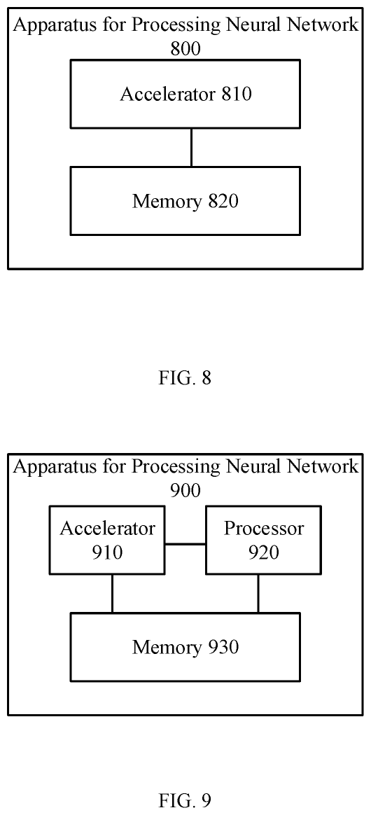

FIG. 8 is a schematic block diagram of a neural network processing apparatus according to some embodiment of the present disclosure. As shown in FIG. 8, the apparatus 800 may include an accelerator 810 and a memory 820.

The accelerator 810 is configured to: read the data of the first block of the plurality of blocks of the k-th layer of the second neural network from the memory 820 when processing the last block of the plurality of blocks of the i-th layer of the first neural network, 1≤i≤N, N being the number of layers of the first neural network, 1≤k≤M, and M being the number of layers of the second neural network; and process the first block of the plurality of blocks of the k-th layer of the second neural network according to the data of the first block of the plurality of blocks of the k-th layer of the second neural network after processing the last block of the plurality of blocks of the i-th layer of the first neural network.

Optionally, in some embodiment of the present disclosure, the accelerator is an on-chip device, and the memory 820 is an off-chip memory.

Optionally, in some embodiment of the present disclosure, the accelerator 810 is further configured to determine the size of the block according to the size of the on-chip memory in the accelerator.

Optionally, in some embodiment of the present disclosure, the memory 820 stores configuration description tables of all the layers of the first neural network and the second neural network. The configuration description table includes configuration parameters for processing all the layers of the first neural network and the second neural network.

Optionally, in some embodiment of the present disclosure, the accelerator 810 is further configured to: read the configuration description table from the memory according to the address information of the configuration description table sent by the processor; and read the data of the block to be processed from the memory according to the configuration description table.

Optionally, in some embodiment of the present disclosure, the address information of the configuration description table is configured to indicate the address of the configuration description table of an initial layer in the memory. The initial layer is the first layer of each neural network or the first layer of the first neural network in the processing order. The accelerator 810 is specifically configured to: read the configuration description table of the initial layer from the memory according to the address information of the configuration description table; and read the configuration description tables of other layers from the memory according to the address information of the configuration description table and the preset address.

Optionally, in some embodiment of the present disclosure, the configuration description of the i-th layer includes an address of the input data of the i-th layer in the memory 820, the address of the output data of the i-th layer is in the memory 820, and the processing instructions for the i-th layer.

The configuration description table of the k-th layer includes an address of the input data of the k-th layer in the memory 820, an address of the output data of the k-th layer in the memory 820, and the processing instructions for the k-th layer.

Optionally, in some embodiment of the present disclosure, the accelerator 810 is further configured to: read the data of the first block of the 1-th layer of the third neural network from the memory 820 when processing the last block of the plurality of blocks of the k-th layer of the second neural network, 1≤1≤P, P being the number of layers of the third neural network; and process the first block of the plurality of blocks of the 1-th layer of the third neural network according to the data of the first block of the plurality of blocks of the 1-th layer of the third neural network after processing the last block of the plurality of blocks of the k-th layer of the second neural network.

FIG. 9 is a schematic block diagram of a neural network processing apparatus according to another embodiment of the present disclosure. As shown in FIG. 9, the apparatus 900 may include an accelerator 910, a processor 920 and a memory 930.

The accelerator 910 is configured to: receive the address information of the configuration description table and the start command sent by the processor 920, the address information of the configuration description table being configured to indicate the address of the configuration description table of the 1-th layer of the neural network in the memory 930, the memory 930 storing configuration description tables of all the layers of the neural network, and the configuration description table of the i-th layer of the neural network including configuration parameters for processing the i-th layer and the start command configured for instructing the start of processing the neural network, 1≤i≤N, N being the number of layers of the neural network; read the configuration description table of the 1-th layer of the neural network from the memory 930 according to the address information of the configuration description table and process the 1-th layer of the neural network according to the configuration description table of the 1-th layer of the neural network; determine the address of the configuration description table of the j-th layer of the neural network in the memory 930 according to a preset address offset, 2≤j≤N, read the configuration description table of the j-th layer from the memory 930 according to the configuration description table of the j-th layer in the memory 930, and process the j-th layer according to the configuration description table of the j-th layer; and send an interrupt request to the processor 920 after processing the N-th layer of the neural network.

Optionally, in some embodiment of the present disclosure, the configuration description table of the i-th layer includes an address of the input data of the i-th layer in the memory 930, and an address of the output data of the i-th layer in the memory 930, and the processing instructions for the i-th layer.

Optionally, in some embodiment of the present disclosure, the accelerator 910 is specifically configured to: read the input data of the i-th layer from the memory 930; process the input data of the i-th layer to obtain the output data of the i-th layer; and store the output data of the i-th layer in the memory 930.

Optionally, in some embodiment of the present disclosure, the accelerator 910 is specifically configured to perform convolution, and BPA operations on the input data of the i-th layer.

Optionally, in some embodiment of the present disclosure, the input data of the i-th layer includes an input feature map and a weight of the i-th layer.

Optionally, in some embodiment of the present disclosure, the interrupt request includes an address of the processing result of the neural network in the memory 930.

Optionally, in some embodiment of the present disclosure, the accelerator 910 and the processor 920 are on-chip devices, and the memory 930 is an off-chip memory.

Optionally, in some embodiment of the present disclosure, the accelerator 910 is further configured to: read the configuration description table of the k-th layer of another neural network from the memory 930 when processing the last block of the plurality of blocks of the i-th layer of the neural network, and read the data of the first block of the plurality of blocks of the k-th layer from the memory 930 according to the configuration description table of the k layer, 1≤k≤M, M being the number of layers of another neural network; process the first block in the of the plurality of blocks in the k-th layer according to the configuration description table of the k-th layer and the data of the first block of the plurality of blocks of the k-th layer after processing the last block of the plurality of blocks of the i-th layer of the neural network.

It should be understood that the apparatus for processing the neural network in the foregoing embodiments of the present disclosure may be a chip, which may be implemented by a circuit, but the embodiments of the present disclosure are not limited to a specific implementation form.

It should also be understood that the foregoing described accelerator in the embodiments of the present disclosure may also be implemented separately; that is, the accelerator may also be separated from other components.

Some embodiment of the present disclosure further provides an accelerator, and the accelerator may include a module for executing the methods of the foregoing various embodiments of the present disclosure.

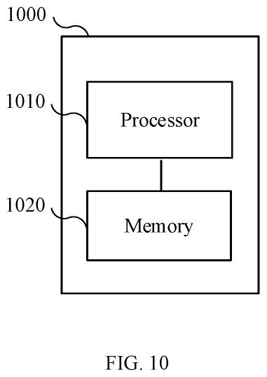

FIG. 10 is a schematic block diagram of a computer system according to some embodiment of the present disclosure.

As shown in FIG. 10, the computer system 1000 may include a processor 1010 and a memory 1020.

It should be understood that the computer system 1000 may also include components generally included in other computer systems, such as input-output devices, communication interfaces, etc., which is not limited by the embodiments of the present disclosure.

The memory 1020 is configured to store computer-executable instructions.

The memory 1020 may be various types of memory, for example, it may include a high-speed random-access memory (RAM), and may also include a non-volatile memory such as at least one disk memory, which is not limited by the embodiments of the present disclosure.

The processor 1010 is configured to access the memory 1020 and execute the computer-executable instructions to perform operations in a method for processing a neural network according to various embodiments of the present disclosure.

The processor 1010 may include a microprocessor, a field-programmable gate array (FPGA), a central processing unit (CPU), a graphics processing unit (GPU), etc., which is not limited by the embodiments of the present disclosure.

Some embodiment of the present disclosure further provides a movable device, and the movable device may include a neural network processing apparatus, an accelerator, or a computer system according to various embodiments of the present disclosure described above.

The apparatus, accelerator, computer system, and movable device for neural network processing according to the embodiments of the present disclosure may correspond to the execution body for performing the method for processing the neural network according to the embodiments of the present disclosure. And the foregoing and other operations and/or functions in each module of the apparatus, accelerator, computer system and the movable device for neural network processing are to implement the corresponding processes of the foregoing methods, respectively, and for brevity, are not described herein again.

Some embodiment of the present disclosure further provides a computer storage medium. The computer storage medium stores program code, and the program code may be configured to perform the method for processing the neural network in the foregoing described embodiments of the present disclosure.

It should be understood that, in the embodiments of the present disclosure, the term “and/or” is merely a relationship describing a related object, indicating that there may be three relationships. For example, A and/or B indicates three cases, A alone, A and B, and B alone. In addition, the character “/” in this text generally indicates that the related objects are in an alternative (“or”) relationship.

Those of ordinary skill in the art may realize that the units and algorithm steps of each example described in connection with the embodiments disclosed herein can be implemented by electronic hardware, computer software, or a combination of the two. In order to clearly illustrate the interchangeability between hardware and software, the composition and steps of each example have been described generally in terms of functions in the above description. Whether these functions are performed in hardware or software depends on the specific application and design constraints of the technical solution. A person skilled in the art can use different methods to implement the described functions for each specific application, but such implementation should not be considered to be beyond the scope of the present disclosure.

Those skilled in the art can clearly understand that, for the convenience and brevity of description, the specific operating processes of the system, apparatus, and units described above can be referred to the corresponding processes in the foregoing method embodiments, and are not described herein again.

In the several embodiments provided in this application, it should be understood that the disclosed system, apparatus, and method may be implemented in other ways. For example, the apparatus embodiments described above are only schematic. For example, the division of the unit is only a logical function division. In actual implementation, there may be another division manner. For example, multiple units or components may be combined or can be integrated into another system, or some features can be ignored or not implemented. In addition, the displayed or discussed mutual coupling or direct coupling or connection may be indirect coupling or connection through some interfaces, devices, or units, or may be electrical, mechanical, or other forms of connection.

The units described as separate components may or may not be physically separated. The components displayed as units may or may not be physical units, may be located in one place, or may be distributed to multiple network units. Some or all of the units may be selected according to actual needs to achieve the objectives of the solutions of the embodiments of the present disclosure.

In addition, each functional unit in each embodiment of the present disclosure may be integrated into one processing unit, or each unit may exist separately physically, or two or more units may be integrated into one unit. The above integrated unit may be implemented in the form of hardware or in the form of software functional unit.

When the integrated unit is implemented in the form of a software functional unit and sold or used as an independent product, it may be stored in a computer-readable storage medium. Based on this understanding, the technical solution of the present disclosure is essentially a part that contributes to the existing technology, or all or part of the technical solution may be embodied in the form of a software product, which is stored in a storage medium, including some instructions for causing a computer device (which may be a personal computer, a server, or a network device, etc.) to perform all or part of the steps of the method described in the embodiments of the present disclosure. The foregoing storage medium includes flash drive, mobile hard disks, read-only memory (ROM), random-access memory (RAM), magnetic disks, or optical disks and other medium that can store program codes.

The above description is only specific embodiments of the present disclosure, but the protected scope of the present disclosure is not limited to this. Any person skilled in the art can easily think of various kinds of equivalent modifications or substitutions within the technical scope disclosed by the present disclosure. The modifications or substitutions should be covered by the protected scope of the present disclosure. Therefore, the protected scope of the present disclosure shall be in conformity with the protected scope of the appended claims.

What is claimed is:

1. A method for processing across neural networks, comprising:
when processing a last block of a plurality of blocks of an i-th layer of a first neural network, 1≤i≤N, N being a number of layers of the first neural network, reading data of a first block of a plurality of blocks of a k-th layer of a second neural network from a memory, 1≤k≤M, and M being a number of layers of the second neural network; and
processing the first block of the plurality of blocks of the k-th layer of the second neural network according to the data of the first block of the plurality of blocks of the k-th layer of the second neural network after processing the last block of the plurality of blocks of the i-th layer of the first neural network.

2. The method according to claim 1, wherein a size of the block is determined according to a size of an on-chip memory.

3. The method according to claim 1, wherein:
the memory stores configuration description tables of all layers of the first neural network and the second neural network, and
the configuration description tables include configuration parameters for processing all layers of the first neural network and the second neural network.

4. The method according to claim 3, further comprising:
reading a configuration description table from the memory according to address information of the configuration description table sent by a processor; and
reading data of a to-be-processed block-from the memory according to the configuration description table.

5. The method according to claim 4, wherein:
the address information of the configuration description table is configured to indicate the address of the configuration description table of an initial layer in the memory, the initial layer being a first layer of each neural network or the first layer of the first neural network in a processing sequence;
reading the configuration description table from the memory according to the address information of the configuration description table sent by the processor comprises:
reading the configuration description table of the initial layer from the memory according to the address information of the configuration description table; and
reading configuration description tables of other layers from the memory according to the address information of the configuration description table and a preset address offset.

6. The method according to claim 3, wherein:
the configuration description table of the i-th layer comprises:
an address of input data of the i-th layer in the memory,
an address of output data of the i-th layer in the memory, and
a processing instruction for the i-th layer;
and
the configuration description table of the k-th layer comprises:
an address of input data of the k-th layer in the memory,
an address of output data of the k-th layer in the memory, and
a processing instruction for the k-th layer.

7. The method according to claim 1, wherein the memory is an off-chip memory.

8. The method according to claim 1, further comprising:
reading data of the first block of the plurality of blocks of the 1-th layer of a third neural network from the memory when processing the last block of the plurality of blocks of the k-th layer of the second neural network, 1≤1≤P, P being a number of layers of the third neural network; and
processing the first block of the plurality of blocks of the 1-th layer of the third neural network according to the data of the first block of the plurality of blocks of the 1-th layer of the third neural network, after processing the last block of the plurality of blocks of the k-th layer of the second neural network.

9. A method for processing across neural networks, comprising:
receiving address information of a configuration description table and a start command sent by a processor, the address information of the configuration description table being configured to indicate an address of a configuration description table of a first layer of a first neural network in a memory, the memory storing configuration description tables of all layers of the first neural network, a configuration description table of an i-th layer of the first neural network including configuration parameters for processing the i-th layer, the start command being configured to instruct a start of processing the first neural network, 1≤i≤N, and N being a number of layers of the first neural network;
reading the configuration description table of the first layer of the first neural network from the memory according to the address information of the configuration description table and processing the first layer of the first neural network according to the configuration description table of the first layer of the first neural network;
determining an address of the configuration description table of a j-th layer of the first neural network in the memory according to a preset address offset, 2≤j≤N; reading the configuration description table of the j-th layer from the memory according to the address of the configuration description table of the j-th layer; and processing the j-th layer according to the configuration description table of the j-th layer; and
sending an interrupt request to the processor after processing the N-th layer of the first neural network.

10. The method according to claim 9, wherein the configuration description table of the i-th layer comprises:
an address of input data of the i-th layer in the memory,
an address of output data of the i-th layer in the memory, and
a processing instruction for the i-th layer.

11. The method according to claim 9, wherein processing the i-th layer of the first neural network comprises:
reading input data of the i-th layer from the memory;
processing the input data of the i-th layer to obtain output data of the i-th layer; and
storing the output data of the i-th layer in the memory.

12. The method according to claim 11, wherein processing the input data of the i-th layer comprises:
performing convolution and BAP operations on the input data of the i-th layer.

13. The method according to claim 10, wherein the input data of the i-th layer comprises an input feature map and a weight of the i-th layer.

14. The method according to claim 9, wherein the interrupt request comprises an address of a processing result of the first neural network in the memory.

15. The method according to claim 9, wherein the memory is an off-chip memory.

16. The method according to claim 9, further comprising:
reading a configuration description table of a k-th layer of a second neural network from the memory when processing a last block of a plurality of blocks of the i-th layer of the first neural network; reading data of a first block of a plurality of blocks of the k-th layer from the memory according to the configuration description table of the k-th layer, 1≤k≤M, M being a number of layers of the second neural network; and
processing the first block of the plurality of blocks of the k-th layer according to the configuration description table of the k-th layer and the data of the first block of the plurality of blocks of the k-th layer, after processing the last block of the plurality of blocks of the i-th layer of the first neural network.

17. An apparatus for processing across neural networks, comprising:
an accelerator, and
a memory;
wherein the accelerator is configured to:
when processing a last block of a plurality of blocks of an i-th layer of a first neural network, 1≤i≤N, N being a number of layers of the first neural network, read data of a first block of a plurality of blocks of a k-th layer of a second neural network from the memory, 1≤k≤M, and M being a number of layers of the second neural network; and
process the first block of the plurality of blocks of the k-th layer of the second neural network according to the data of the first block of the plurality of blocks of the k-th layer of the second neural network, after processing the last block of the plurality of blocks of the i-th layer of the first neural network.

18. An accelerator, configured to perform a method for processing across neural networks, comprising:
when processing a last block of a plurality of blocks of an i-th layer of a first neural network, 1≤i≤N, N being a number of layers of the first neural network, reading data of a first block of a plurality of blocks of a k-th layer of a second neural network from a memory 1≤k≤M, and M being a number of layers of the second neural network; and
processing the first block of the plurality of blocks of the k-th layer of the second neural network according to the data of the first block of the plurality of blocks of the k-th layer of the second neural network after processing the last block of the plurality of blocks of the i-th layer of the first neural network.

19. A movable device for processing across neural networks, comprising:
an accelerator,
a computer system, comprising:
a memory for storing executable computer instructions, and
a processor for executing the executable computer instructions stored in the memory;
wherein the accelerator is configured to:
when processing a last block of a plurality of blocks of an i-th layer of a first neural network, 1≤i≤N, N being a number of layers of the first neural network, read data of a first block of a plurality of blocks of a k-th layer of a second neural network from the memory 1≤k≤M, and M being a number of layers of the second neural network; and
process the first block of the plurality of blocks of the k-th layer of the second neural network according to the data of the first block of the plurality of blocks of the k-th layer of the second neural network, after processing the last block of the plurality of blocks of the i-th layer of the first neural network.
